(19) United States
(12) Patent Application Publication
(10) Pub. No.: US 2008/0295286 A1
(43) Pub. Date: Dec. 4, 2008

(54) Hinge Cover Assembly

(76) Inventors: Rory Patrick Falato, West Chester, OH (US); Robert Joseph Clark, Cincinnati, OH (US); Marvin L. Wollam, Redmond, OR (US)

Correspondence Address: FROST BROWN TODD, LLC, 2200 PNC CENTER, 201 E. FIFTH STREET, CINCINNATI, OH, 45202, US

(21) Appl. No.: 12/129,944

(22) Filed: May 30, 2008

Related U.S. Application Data
(60) Provisional application No. 60/941,107, filed on May 31, 2007.

(51) Int. Cl. E05D 11/00

(52) U.S. Cl. 16/250

(57) ABSTRACT

A hinge cover comprising a mounting plate, a cup, a wrap, and a bushing. In this version, the mounting plate comprises a vertical portion, a horizontal portion, a right side member and a left side member. The cup comprises a base member, a perimeter member, a right attachment member and a left attachment member. The right attachment member and left attachment member may be configured to allow the cup to slide vertically during use. The wrap comprises a right edge and a left edge. In this embodiment, the right edge is attached to the right side member and the right support member, and the left edge is attached to the left side member and the left support member. The cup is configured to slide vertically relative to the wrap during use. The bushing configured to engage the cup comprising a lower portion and an upper lip.

### PRIORITY INFORMATION

This application claims priority to U.S. Provisional Patent Application No. 60/941,107 filed May 31, 2007, entitled “Hinge Cover Assembly,” the disclosure of which is incorporated by reference herein.

### BACKGROUND

Embodiments of a hinge cover assembly described herein are related generally to hinges and doors. In particular, embodiments of a hinge cover assembly described herein are related to protecting a hinge and reducing the air-flow around the edges of doors. More specifically, embodiments of a hinge cover assembly described herein may be configured to be attached to a double-acting traffic door with a V-Cam style hinge.

Due to rising fuel costs and a growing desire to reduce environmental impact, increasing energy efficiency in buildings has become more important in recent years. One particular challenge to sustaining high energy efficiency is maintaining different temperatures in adjoining portions of a building. Minimizing the amount of air-flow between spaces may improve the overall energy efficiency of the building and the various environmental control systems, such as the HVAC system.

Typically, these adjoining portions of the building are separated by traffic doors. Various improvements have been made to the door design to improve energy efficiency, including the use of air tight door to jamb seals to restrict the flow of air around the door panels and automatic closing to minimize the amount of time the door is open. However, traffic doors generally include hinge cutouts where the door panel is attached to the hinges. Despite other efforts to reduce air flow around the doors, air can still typically flow freely between rooms around the opening created by the hinges and hinge cutouts on the top and bottom of the door.

In an effort to hide the hinges, most conventional door and hinge designs typically provide a wrap configured to be attached around the hinge. The wraps are usually made from a flexible plastic or textile material and include a “skirt” of vertically cut material located around the lower portion. FIGS. 1-2 depict a pair of examples of these prior art wraps, one of which has been damaged during use, as shown in FIG. 2. Generally, in order to allow the weight of the door to cause the door to return to a closed position, hinges are configured to rise and fall as the door opens. As the hinge rises and falls, the door also must rise and fall during opening and closing. The skirt is configured to allow the door attached to the hinge to swing and rise with minimal obstruction from the wrap. Traditional wraps may be used on either the upper hinge, as shown in FIGS. 1 and 2, or on the lower hinge.

This design has several problems. First, due to the soft and flexible nature of the material, traditional wraps are prone to damage, as shown in FIG. 2. Traditional wraps may be easily ripped or torn if the wrap is caught in the hinge during opening and closing, such as the wrap shown in FIG. 2. In particular, the wraps are susceptible to ripping and tearing at both the skirt portion and at the points where the wrap is attached to the hinge and/or mounting plate. For example, the skirt portions of the wrap depicted in FIG. 2 has been torn off during use, and the wrap shown in FIG. 8 has ripped away from its attachment to the mounting plate. Second, wraps generally provide little to no reduction in air movement between the spaces separated by the doors. As shown in FIG. 1, even when a traditional wrap has not been damaged, there are still substantial gaps around the door through which air can easily flow unobstructed. In order to allow the door to rise without obstruction, the wrap is not attached to the door surface, thereby allowing air to flow freely through the hinge cutout in the door panel.

Therefore, it may be desirable to provide a hinge cover assembly that is not prone to damage and is configured to at least partially reduce airflow between the spaces separated by the door.

### BRIEF DESCRIPTION OF THE DRAWINGS

It is believed the present invention will be better understood from the following description of certain examples taken in conjunction with the accompanying drawings, in which like reference numerals identify the same elements and in which:

FIG. 1 depicts a perspective environmental view of a prior art wrap surrounding an upper hinge.

FIG. 2 depicts a perspective environmental view of an alternate prior art wrap that has had the skirt portion ripped off during use.

FIG. 3 depicts a perspective view of an exemplary embodiment of a hinge cover assembly, comprising a cup, a wrap and a mounting plate, constructed in accordance with the present invention.

FIG. 4 depicts a perspective assembly view of the hinge cover assembly shown in FIG. 3.

FIG. 5 depicts a perspective environmental view of the hinge cover assembly shown in FIG. 3 attached to a hinge.

FIG. 6 depicts a front view of several components of an alternate embodiment of a hinge cover assembly, comprising a cup, a mounting plate, and a hinge cam, constructed in accordance with the present invention.

FIG. 7 depicts a side view of the several components shown in FIG. 6.

FIG. 8 depicts a perspective view of the several components shown in FIG. 6.

FIG. 9 depicts a plan view of the cup shown in FIGS. 3-8.

FIG. 10 depicts a side view of the cup shown in FIGS. 3-8.

FIG. 11 depicts a front view of the cup shown in FIGS. 3-8.

FIG. 12 depicts a perspective view of the cup shown in FIGS. 3-8.

FIG. 13 depicts a front view of an exemplary bushing.

FIG. 14 depicts plan view of the bushing shown in FIG. 13.

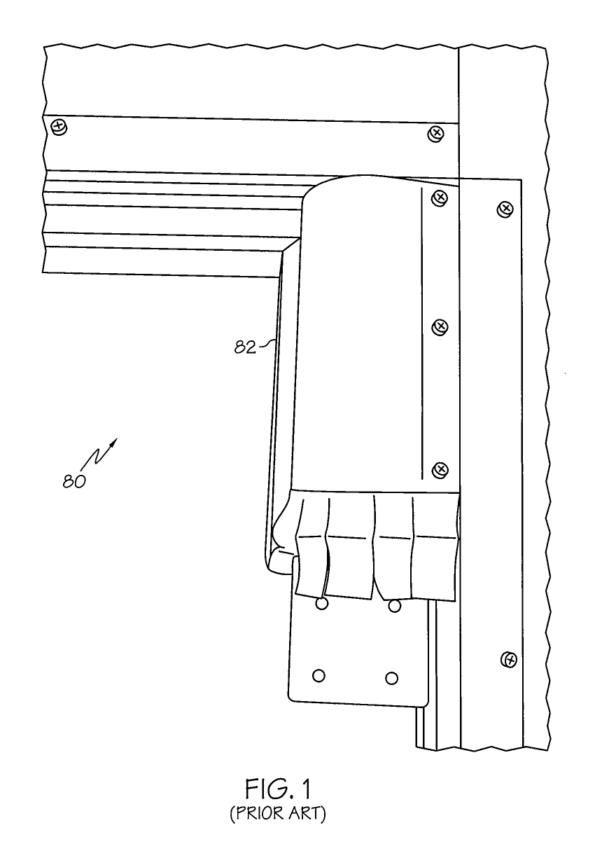

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one mode contemplated for carrying out the invention. As will be realized, the invention is capable of other different and obvious aspects, all without departing from the invention. Accordingly, the drawings and descriptions should be regarded as illustrative in nature and not restrictive.

It will be appreciated that for convenience and clarity, spatial terms such as “right”, “left”, “upper”, and “lower” are used herein with respect to the drawings. However, hinge cover assemblies may be used in a variety of positions, and these terms are not intended to be limiting and absolute.

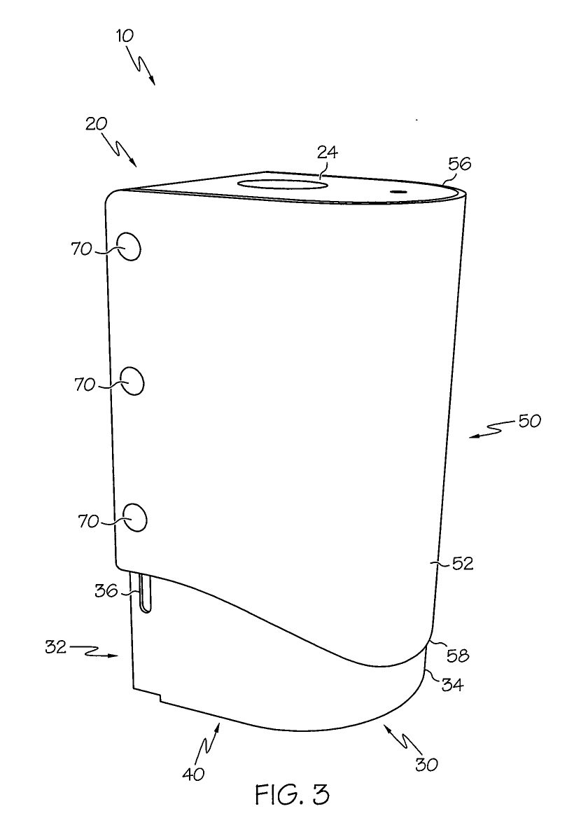

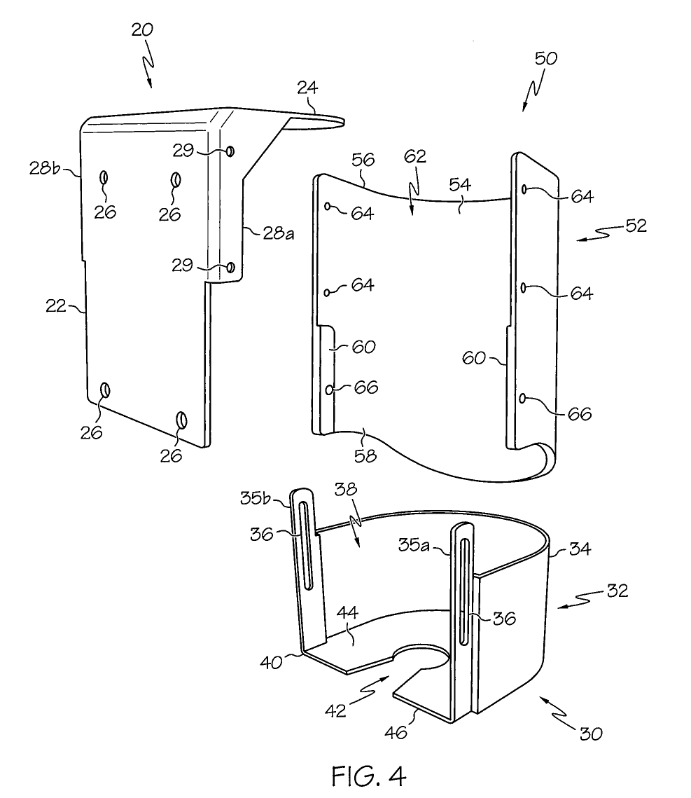

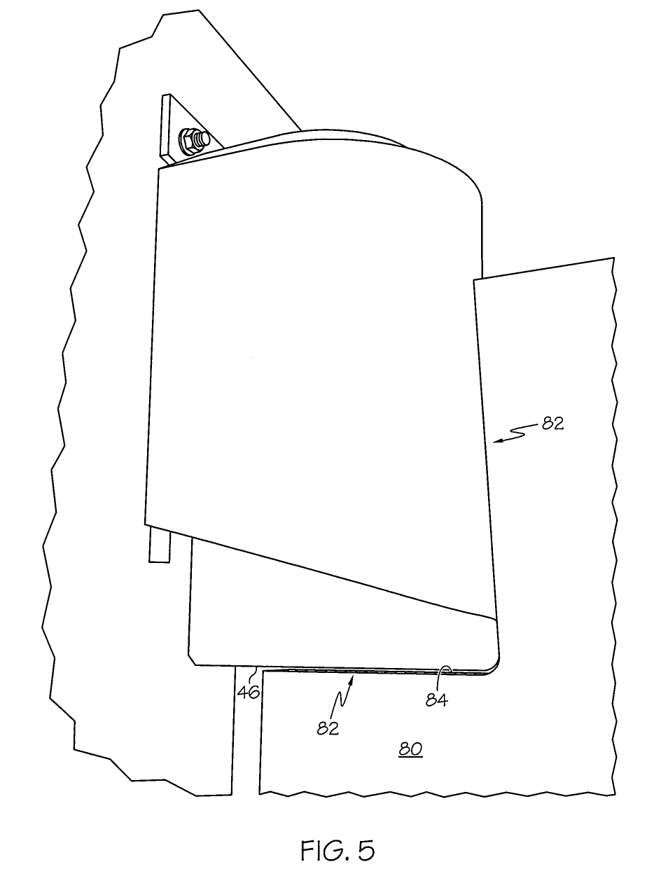

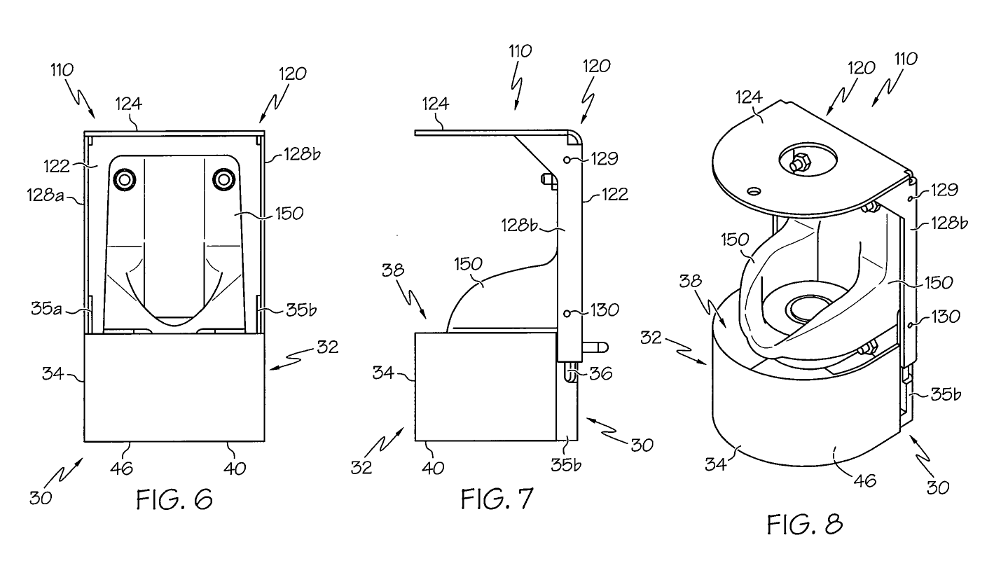

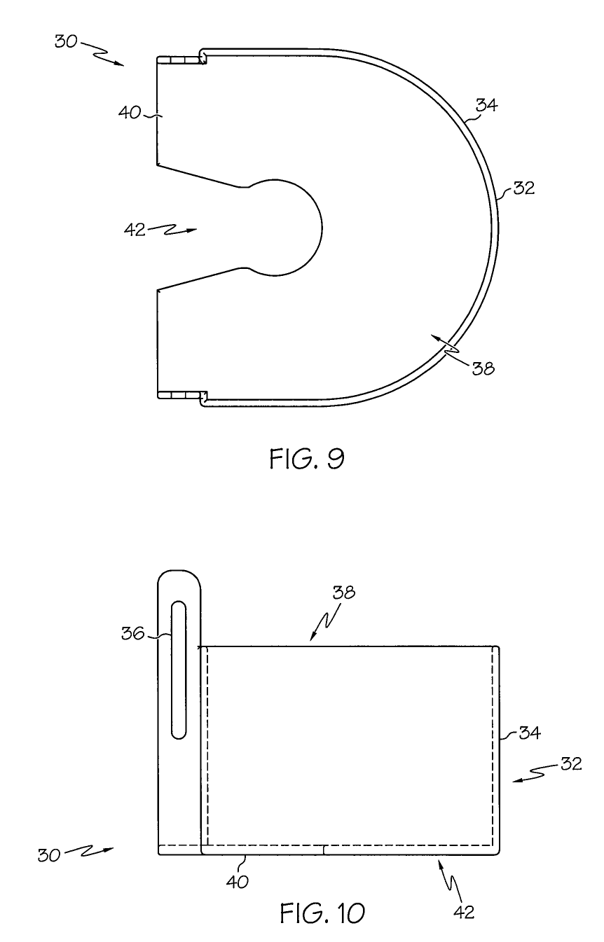

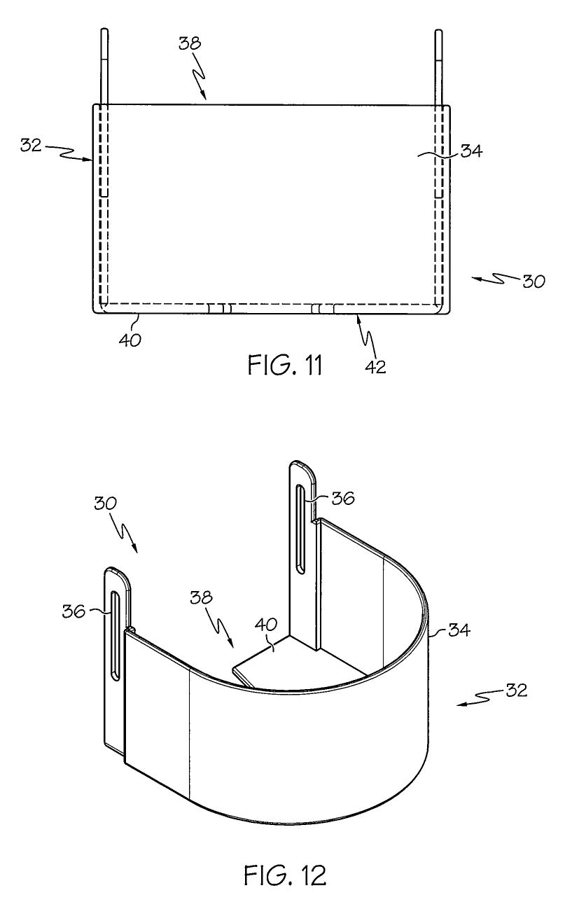

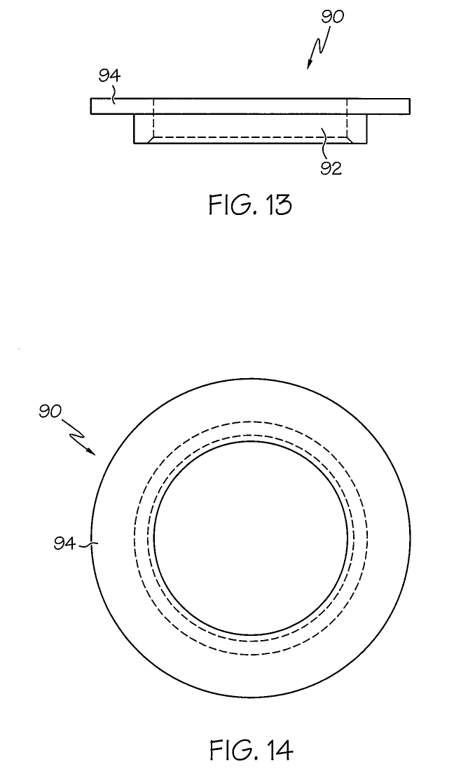

Embodiments of the present invention may be configured to be used with any suitable door and hinge assembly wherein the door includes a hinge cutout in the door panel and a hinge configured to allow the door panel to rise when opened and descend when returned to the closed position, including, but not limited to a double-action traffic door with a V-Cam style hinge. One embodiment of a hinge cover assembly is shown in FIGS. 3-5, wherein the assembly 10 comprises a mounting plate 20, a cup 30, and a wrap 50. FIGS. 6-8 illustrate an alternate embodiment of a hinge cover assembly 110 including the cup 30 shown in FIGS. 3-5, an alternate mounting plate 120, and a hinge cam 150. Although not shown as part of the assemblies shown in FIGS. 3-8, it should be noted that embodiments of the present invention may additionally comprise a bushing, such as the one shown in FIGS. 13-14. FIGS. 9-12 depict various views of the cup 30 shown in FIGS. 3-8.

As shown in FIGS. 3-5, mounting plate 20 comprises a vertical portion 22, a horizontal portion 24, and a pair of side members: right side member 28a and left side member 28b. Similarly, mounting plate 120 shown in FIGS. 6-8 also comprises a vertical portion 122, a horizontal portion 124, and a pair of side members: right side member 128a and left side member 128b. Both embodiments of the mounting plate 20, 120 may be configured to be mounted to a flat portion of a door jamb, a corner portion of a door jamb, or any other suitable surface by attaching the vertical portion to the surface.

In the version shown in FIGS. 3-5, the vertical portion 22 includes four surface mounting apertures 26 configured to allow the mounting plate 20 to be attached to a mounting surface. Any suitable number of surface mounting apertures 26 in any suitable arrangement may be used. Of course, these surface mounting apertures 26 are not required, and the mounting plate 20, 120 may be attached to a mounting surface using a fastener that requires a mounting aperture, a fastener that does not require a mounting aperture, adhesive or any other suitable device or method.

In addition, as shown in FIGS. 3-5, right side member 28a includes a pair of wrap attachment apertures 29 configured to allow wrap 50 to be attached to the mounting plate 20. Similar to the surface mounting apertures 26, the wrap attachment apertures are not required and any suitable number of wrap attachment apertures 29 in any suitable arrangement may be used. Although not shown in FIGS. 3-5, left side member 28b may also include one or more wrap attachment apertures, but that is not required. The wrap 50 may be attached to the mounting plate 20 using a fastener that requires a mounting aperture, a fastener that does not require a mounting aperture, adhesive, or any other suitable device or method. Similarly, FIGS. 6-8 show mounting plate 120 comprising a wrap attachment aperture 129 in left side member 128b. Of course, a wrap attachment aperture 129 is not required and any suitable number of wrap attachment apertures 129 may be used in any suitable arrangement. Although not shown in FIGS. 6-8, right side member 128a may also include one or more wrap attachment apertures, but that is not required. A wrap may be attached to the mounting plate 120 using a fastener that requires a mounting aperture, a fastener that does not require a mounting aperture, adhesive, or any other suitable device or method.

As shown in FIGS. 6-8, left side member 128b comprises a cup mounting aperture 130 configured to allow the cup 30 to be attached to the mounting plate 120 via mounting slots 36 formed in the cup 30. Although not shown, right side member 128a may similarly comprise a cup mounting aperture configured to allow the cup 30 to be attached to the mounting plate 120. Of course, the cup mounting apertures 130 are not required and any suitable number of cup mounting apertures may be used in any suitable arrangement. The cup 30 may be attached to the mounting plate 120 using any suitable fastener, device, or method, including fasteners that requires a mounting aperture and fasteners that do not require a mounting aperture. In addition, as shown in FIGS. 6-8, mounting plate 120 is configured to allow one or more hinge components, such as hinge cam 150, to be attached to mounting plate 120. The mounting plate 20, 120 may comprise metal, plastic, or any other suitable material. It should be noted that, although FIGS. 6-8 do not depict a wrap, mounting plate 120 may be configured to be assembled with a wrap similar to wrap 50 shown in FIGS. 3-5 and described below.

Although the mounting and attachment apertures 26, 29, 126, 129, 130 described above and shown in FIGS. 3-8 are circular, it should be noted that the apertures may be any suitable size and shape.

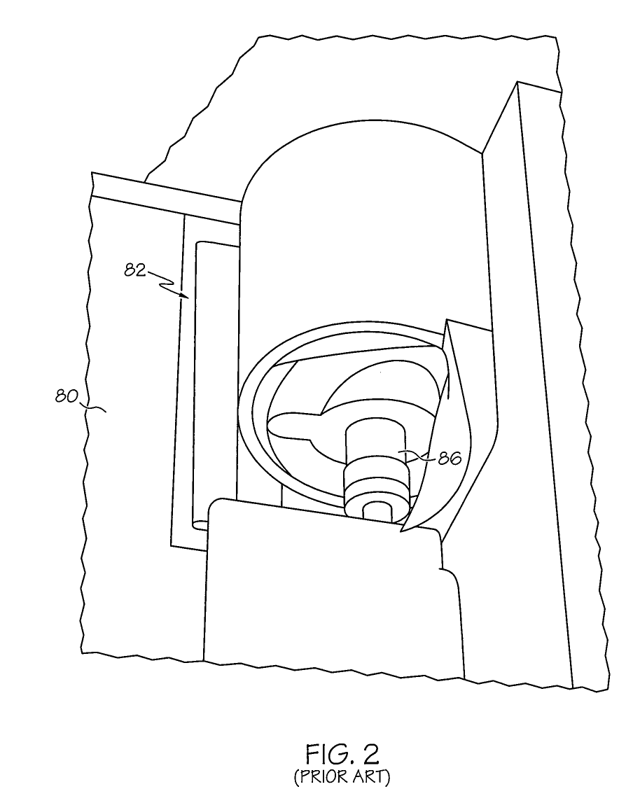

As shown in FIGS. 3-12, cup 30 has a u-shaped profile and comprises a perimeter member 32 and a base member 40. It will be appreciated that a cup may have any suitable shape, size or profile. In this embodiment, perimeter member 32 is curved and projects vertically along the outer edge of base member 40. In this example, the perimeter member 32 comprises an outer surface 34, a right attachment member 35a and a left attachment member 35b. In the illustrated version, right attachment member 35a and left attachment member 35b comprise mounting slots 36 configured to allow cup 30 to be attached to either the wrap 50, as shown in FIGS. 3-5, and/or the mounting plate 120, as shown in FIGS. 6-8. Cup 30 may be attached to the wrap 50 and/or the mounting plate 120 using a fastener, an adhesive, or any other suitable device or method. As shown, base member 40 comprises an opening 42, an upper surface 44, and a lower surface 46. In the illustrated embodiment, the opening 42 is configured to allow the cup 30 to be positioned around a hinge shaft, such as hinge shaft 86 shown in FIG. 2, such that the hinge shaft passes through the opening 42 into the interior cavity 38 of the cup. The cup 30 may be positioned around the hinge shaft such that the lower surface 46 of the base member 40 is generally adjacent to the exposed surface 84 of the door panel 80 exposed by a hinge cutout 82.

The assembly 10, 110 may include a bushing, such as bushing 90 shown in FIGS. 13-14, placed around a hinge shaft, such as hinge shaft 86, and engaged by cup 30. Bushing 90 may be configured to allow the hinge shaft to rotate without causing cup 30 to rotate. In addition, bushing 90 may be configured to facilitate uniform vertical movement of cup 30 and the door panel during opening and closing by providing a force sufficient to cause the lower surface 46 of base member 40 to remain adjacent to the exposed surface 84 of the door panel 80 during opening and closing. As shown in FIGS. 13-14, bushing 90 includes a lower portion 92 with a first diameter and an upper lip 94 having a larger diameter than lower portion 92 in order to act as a retainer. The bushing 90 may be press fitted onto a hinge shaft, such as hinge shaft 86 shown in FIG. 2, and positioned adjacent to the exposed surface 84 of the door panel 80 exposed by the hinge cutout 82. Cup 30 may then be positioned generally adjacent to exposed surface 84 such that opening 42 in base member 40 of cup 30 engages lower portion 92 of bushing 90. In this version, as door panel 80 rises during opening, exposed surface 84 abuts lower surface 46 of base member 40 of cup 30 and forces cup 30 to rise also. As door panel 80 returns to the closed position, upper lip 94 of bushing 90 abuts upper surface 44 of base member 40 of cup 30 and pulls cup 30 downward to follow the downward motion of door panel 80. In this manner, the assembly 10, 110 retains substantially the same dimensional relationship between door panel 80 and cup 30. It will be appreciated that gravity alone may be sufficient to cause cup 30 to return to its lower position during closing; however, upper lip 94 may eliminate the need to rely on gravity alone to return cup 30 to its lower position.

Mounting slots 36 in cup 30 may be configured to allow cup 30 to remain attached to wrap 50 and/or mounting plate 120 as cup 30 moves vertically during opening and closing of door panel 80. Mounting slots 36 may be configured as vertical slots, as shown in FIGS. 9-18, or any other suitable shape or configuration. Interior cavity 38 of cup 30 may be configured to provide sufficient space for the hinge components to operate during opening and closing without coming into contact with cup 30. As shown in FIGS. 6-8, cup 30 is configured to rise and fall around hinge cam 150 without coming into contact with hinge cam 150. Cup 30 may be configured to visually contain the lower portion of the hinge, such as, for example a hinge shaft, such as hinge shaft 86 shown in FIG. 2, projecting from a door panel to a hinge cam. Cup 30 may also be configured to substantially occupy the lower portion of the space created by hinge cutout 82 in door panel 80. Cup 30 may comprise plastic, metal or any other suitable material and may be formed using injection molding, conventional metal forming techniques known within the art, or any other suitable method or device.

As shown in FIGS. 3-5, wrap 50 comprises a curved member 52 with an inner surface 54, an upper edge 56, and a lower edge 58. In the illustrated version, lower edge 58 is sloped at an angle corresponding to the vertical movement of the door panel 80 during opening and closing. In this example, wrap 50 has a u-shaped profile, but, it should be noted that wrap 50 may comprise any suitable shape or profile. Wrap 50 comprises a plurality of mounting plate attachment apertures 64 configured to allow wrap 50 to be attached to a mounting plate, such as mounting plates 20 and 120. Any suitable number of mounting plate attachment apertures 64 in any suitable arrangement may be used. Of course, these mounting plate attachment apertures 64 are not required, and wrap 50 may be attached to a mounting plate 20, 120 using a fastener that requires a mounting aperture, a fastener that does not require a mounting aperture, adhesive or any other suitable device or method. In the illustrated version, wrap 50 is attached to mounting plate 20 via fasteners 70 inserted through mounting plate attachment apertures 64.

As shown in FIGS. 3-5, wrap 50 comprises a pair of support members 60 projecting from inner surface 54 of curved member 52. In this example, support members 60 are configured to correspond to mounting slots 36 in cup 30 to facilitate attachment between cup 30 and wrap 50. In the illustrated version, support members 60 include cup attachment apertures 66, and support members 60 are configured to allow cup 30 to move vertically along with the door panel 80 while wrap 50 remains relatively stationary. Of course, the support members 60 are not required, and the inner surface 54 of the wrap 50 may be substantially smooth and free from any projections. Any suitable number of cup attachment apertures 66 may be used in any suitable arrangement. Of course, cup attachment apertures 66 are not required, and wrap 50 may be attached to cup 30 using a fastener that requires a mounting aperture, a fastener that does not require a mounting aperture, adhesive or any other suitable device or method. In the illustrated version, wrap 50 is attached to cup 30 via fasteners 70 inserted through cup attachment apertures 66. Similar to cup 30, wrap 50 may be configured to create an inner cavity 62 large enough to provide sufficient space for the hinge components to operate during opening and closing without coming into contact with wrap 50. Wrap 50 may be configured to visually contain the upper portion of the hinge and substantially occupy the upper portion of the space created by the hinge cutout 82 in the door panel 80. Wrap 50 may comprise plastic or any other suitable material, and wrap 50 may be formed using injection molding or any other suitable method or device. Wrap 50 may comprise a rigid material, a flexible material, or any other suitable material.

In this version, wrap 50 and cup 30 are configured to overlap, such that inner surface 54 of wrap 50 is positioned adjacent to outer surface 34 of cup 30. Lower edge 58 of wrap 50 is configured to reveal a portion of cup 30, while upper edge 56 of wrap 50 is configured to fit flush with horizontal portion 24 of mounting plate 20 upon attachment to mounting plate 20. Thereby, the assembly 10, 110 is configured to contain the entire hinge and substantially occupy the space created by hinge cutout 82 in door panel 80. In addition to obstructing air movement through hinge cutout 82, the assembly 10, 110 may be configured to visually conceal the hinge, thereby providing a more aesthetically pleasing door. By substantially occupying the space created by hinge cutout 82 in door panel 80, the present embodiment may reduce airflow around the hinge through hinge cutout 82, thereby improving the energy efficiency of the building. In addition, embodiments of a hinge cover assembly may reduce the high rate of damage typically associated with conventional wraps. The present embodiment is configured to allow the hinge to operate in all directions without coming into contact with any of the components of the assembly 10, 110, thereby reducing the likelihood of components of the assembly 10, 110 getting caught in the hinge during opening and closing. In addition, in this example, the assembly 10, 110 does not include any loose edges capable of being snagged in the hinge as the door opens and closes, such as the skirt in conventional wraps. The components of this embodiment may be made out of more rigid material than conventional wraps, such as hard plastic for the cup and a more rigid plastic for the wrap, in order to provide increased protection for the enclosed hinge, while preventing the components of the cover assembly from getting caught in the hinge as the door opens and closes.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

What is claimed is:

1. A hinge cover assembly comprising:
a mounting plate comprising
a vertical portion comprising an upper edge, a right edge and a left edge,
a horizontal portion attached to the vertical portion,
a right side member attached to the vertical portion, and
a left side member positioned opposite to the right side member and attached to the vertical portion;
a cup comprising
a base member comprising a lower opening and an edge,
a perimeter member extending substantially perpendicularly adjacent to the edge of the base member, wherein the perimeter member comprises a right edge and a left edge,
a right attachment member attached to the right edge of the perimeter member, and
a left attachment member attached to the left edge of the perimeter member,
wherein the right attachment member and the left attachment member are configured to allow the cup to slide vertically during use;
a wrap comprising a right edge and a left edge, wherein the right edge of the wrap is attached to the right side member of the mounting plate and the right support member of the cup, wherein the left edge of the wrap is attached to the left side member of the mounting plate and the left support member of the cup, wherein the cup is configured to slide vertically relative to the wrap during use; and
a bushing configured to engage the cup and comprising a lower portion and an upper lip, wherein the lower portion is positioned within the lower opening in the base member of the cup, wherein the upper lip abuts the base member of the cup.

2. The hinge cover assembly of claim 1 further comprising an interior cavity, wherein the interior cavity is formed by the cup, the mounting plate, and the wrap, wherein the interior cavity is configured to house a hinge, wherein the interior cavity is configured to allow the hinge to operate without contacting the cup, the mounting plate and the wrap.

3. The hinge cover assembly of claim 1 wherein the assembly is configured to be used with a V-Cam style hinge.

4. The hinge cover assembly of claim 1, wherein the vertical portion of the mounting plate further comprises at least one surface mounting aperture configured to allow the mounting plate to be attached to a mounting surface.

5. The hinge cover assembly of claim 1, wherein the right side member of the mounting plate further comprises at least one wrap attachment aperture, wherein the left side member of the mounting plate further comprises at least one wrap attachment aperture, wherein the wrap attachment apertures are configured to allow the wrap to be attached to the mounting plate.

6. The hinge cover assembly of claim 1, wherein the mounting plate is configured to allow at least one hinge component to be attached to the mounting plate.

7. The hinge cover assembly of claim 1, wherein the horizontal portion of the mounting plate further comprises an upper opening, wherein the upper opening is aligned with the lower opening in the base member of the cup.

8. The hinge cover assembly of claim 1, wherein the cup comprises a u-shaped profile.

9. The hinge cover assembly of claim 1, wherein the cup further comprises at least one slot in each of the pair of attachment members, wherein the at least one slot is configured to allow the cup to remain slidably attached to the wrap as the cup slides vertically during use.

10. The hinge cover assembly of claim 1, wherein the wrap comprises a u-shaped profile.

11. The hinge cover assembly of claim 1, wherein the lower edge of the wrap is sloped at an angle to reveal a portion of the cup.

12. The hinge cover assembly of claim 1, wherein the perimeter member of the cup further comprises an outer surface, wherein the wrap further comprise an inner surface, wherein the cup and the wrap overlap such that a portion of the outer surface of the perimeter member of the cup is adjacent to the inner surface of the wrap.

13. The hinge cover assembly of claim 1, wherein the wrap further comprises an upper edge, wherein the upper edge is configured to fit substantially flush with the horizontal portion of the mounting plate.

14. The hinge cover assembly of claim 1, wherein the lower opening of the cup is configured to allow the cup to be positioned around a hinge shaft.

15. The hinge cover assembly of claim 1, wherein the wrap further comprises:
a right support member positioned along a portion of the right edge of the wrap, and
a left support member positioned along a portion of the left edge of the wrap opposite from the right support member,
wherein the right support member and the left support member are configured to correspond with the right attachment member and the left attachment member, respectively to allow the wrap to be slidably attached to the cup.

16. The hinge cover assembly of claim 1, wherein the lower portion of the bushing comprises a first diameter, wherein the upper lip of the bushing comprises a second diameter, wherein the second diameter is larger than the first diameter

17. A hinge cover assembly comprising:
a mounting plate comprising
a vertical portion comprising an upper edge, a right edge and a left edge,
a horizontal portion attached to the vertical portion,
a right side member attached to the vertical portion, and
a left side member positioned opposite to the right side member and attached to the vertical portion;
a cup comprising
a base member comprising a lower opening and an edge,
a perimeter member extending substantially perpendicularly adjacent to the edge of the base member, wherein the perimeter member comprises a right edge and a left edge,
a right attachment member attached to the right edge of the perimeter member, and
a left attachment member attached to the left edge of the perimeter member,
wherein the right attachment member and the left attachment member are slidably attached to the right side member and left side member of the mounting plate, respectively;
a wrap comprising a right edge and a left edge, wherein the right edge of the wrap is attached to the right side member of the mounting plate, wherein the left edge of the wrap is attached to the left side member of the mounting plate; and
a bushing configured to engage the cup and comprising a lower portion and an upper lip, wherein the lower portion is positioned within the lower opening in the base member of the cup, wherein the upper lip abuts the base member of the cup.

18. The hinge cover assembly of claim 17, wherein the assembly is configured to be used with a V-Cam style hinge.

19. A hinge system comprising:
a door panel comprising a cut-out portion;
a mounting plate;
a hinge attached to the door panel at the cut-out portion, wherein the hinge comprises
a hinge cam attached to the mounting plate, the hinge cam configured to allow the door to raise upon opening and descend upon closing, and
a hinge shaft;
a cup configured to conceal at least a portion of the hinge, wherein the cup is slidably attached to the mounting plate;
a wrap configured to conceal at least a portion of the hinge, wherein the wrap is attached to the mounting plate; and
a bushing press fitted onto the hinge shaft and attached to the cup, wherein the bushing is configured to move in unison with the hinge shaft, thereby causing the cup to raise upon opening of the door and descend upon closing of the door in unison with the door.

20. The system of claim 19, wherein the door panel comprises a double-action traffic door and the hinge comprises a V-cam style hinge.
